(19) United States
(12) Patent Application Publication
(10) Pub. No.: US 2004/0156463 A1
(43) Pub. Date: Aug. 12, 2004

(54) System and method for recovering a payload data stream from a framing data stream

(76) Inventors: Anthony A. Goodloe, Huntsville, AL (US); Eric M. Rives, Hampton Cove, AL (US); Matthew A. Kliesner, Madison, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/364,144

(22) Filed: Feb. 11, 2003

(51) Int. Cl. H04L 7/04

(52) U.S. Cl. 375/362

(57) ABSTRACT

A system for recovering a payload data stream from a framing data stream utilizes a buffer, a first counter, a second counter, and a clock synchronization element. The buffer is configured to receive the framing data stream and to store payload bits of the framing data stream. The buffer is further configured to transmit the payload bits based on a clock signal. The first counter is configured to produce a first value and to update the first value for each of the payload bits stored in the buffer. The second counter is configured to produce a second value and to update the second value based on the clock signal. The clock synchronization element is coupled to the first and second counters. The clock synchronization element is configured to compare the first and second values and to control a frequency of the clock signal based on comparisons of the first and second values.

### BACKGROUND OF THE INVENTION

1. Field of the Invention

The present invention generally relates to data communication techniques and, in particular, to a system and method for recovering a payload data stream from a framing data stream such that a clock signal synchronized with the payload data stream is produced.

2. Related Art

In a typical digital communication system, framing information is sometimes inserted into a data stream that is communicated from a transmitting device to a receiving device. The framing bits help the receiving device to achieve synchronization with the incoming data stream. Note that the bits in the data stream defining the inserted framing information are commonly referred to as “framing bits,” and the non-framing bits of the data stream defining the data or “payload” originally transmitted by the transmitting device are commonly referred to as “payload bits.”

Moreover, the incoming data stream, referred to as the “framing data stream,” received by the receiving device comprises both framing bits and payload bits, and it is typically desirable for the receiving device to extract the framing bits from the received data stream in order to recover the data stream, commonly referred to as the “payload stream” or “payload data stream,” originally transmitted by the transmitting device before insertion of the framing bits. Further, a clock signal synchronized with the received framing data stream is often used by the receiving device to receive or capture the bits of the framing data stream. However, once the framing bits are extracted in order to recover the payload data stream, the aforementioned clock signal is no longer precisely synchronized with respect to the recovered data stream (i.e., the payload data stream). In this regard, the payload data stream has fewer data bits than the received framing data stream synchronized with the clock signal, and the payload data stream is, therefore, typically transmitted at a slightly slower data rate than the framing data stream and the clock signal synchronized with the framing data stream.

Moreover, is it generally desirable for the receiving device to generate or otherwise provide a new clock signal that is synchronized with respect to the recovered payload data stream to enable further processing of the payload data stream within the receiving device or downstream of the receiving device. However, the precise transmission rate of the framing data stream received by the receiving device is not normally known prior to the communication session in which the framing data stream is communicated from the transmitting device to the receiving device. Indeed, channel impairments between the transmitting device and the receiving device can induce varied transmission rates during the communication or during different communication sessions between the transmitting device and the receiving device. Further, variations in the transmission rate of the received data stream usually results in variations in the optimum transmission rate of the recovered payload data stream. As a result, the generation of a clock signal that is synchronized with respect to the recovered payload data stream can sometimes be problematic.

### SUMMARY OF THE INVENTION

Generally, the present invention provides a system and method for recovering a payload data stream from a framing data stream.

In architecture, a system in accordance with an exemplary embodiment of the present invention utilizes a buffer, a first counter, a second counter, and a clock synchronization element. The buffer is configured to receive a framing data stream and to store payload bits of the framing data stream. The buffer is further configured to transmit the payload bits based on a clock signal. The first counter is configured to produce a first value and to update the first value for each of the payload bits stored in the buffer. The second counter is configured to produce a second value and to update the second value based on the clock signal. The clock synchronization element is coupled to the first and second counters. The clock synchronization element is configured to compare the first and second values and to control a frequency of the clock signal based on comparisons of the first and second values.

The present invention can also be viewed as providing a method for recovering a payload data stream from a framing data stream. A method in accordance with an exemplary embodiment of the present invention can be broadly conceptualized by the following steps: storing payload bits of a framing data stream in a buffer; transmitting the payload bits from the buffer based on a clock signal; clocking a first counter for each of the payload bits stored in the buffer; clocking a second counter via the clock signal; comparing values produced by the first and second counters; and controlling a frequency of the clock signal based on the comparing step.

Various features and advantages of the present invention will become apparent to one skilled in the art upon examination of the following detailed description, when read in conjunction with the accompanying drawings. It is intended that all such features and advantages be included herein within the scope of the present invention and protected by the claims.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 is a block diagram illustrating an exemplary embodiment of a digital receiver unit in accordance with the present invention.

FIG. 2 is a block diagram illustrating a portion of a framing data stream received by the digital receiver unit of FIG. 1.

FIG. 3 is a block diagram illustrating the data stream portion of FIG. 2 once the data stream portion has been processed by a data recovery system depicted in FIG. 1.

FIG. 4 is a block diagram illustrating an exemplary embodiment of the data recovery system of FIG. 1.

FIG. 5 is a block diagram illustrating an exemplary embodiment of a clock synchronization element depicted in FIG. 4.

FIG. 6 is a state diagram illustrating an exemplary architecture and functionality of a finite state machine depicted in FIG. 5.

FIG. 7 is a state diagram illustrating an exemplary architecture and functionality of the finite state machine of FIG. 5 when fₘ/fₚ is between 4.0 and 5.0.

FIG. 8 is a timing diagram illustrating exemplary relationships between various signals processed by the clock synchronization element of FIG. 4.

FIG. 9 is a flow chart illustrating an exemplary architecture and functionality of the finite state machine of FIG. 5.

### DETAILED DESCRIPTION

The present invention generally pertains to a system and method for recovering a payload data stream from a framing data stream. In accordance with one exemplary embodiment of the present invention, a framing data streaming having payload bits and framing bits is received by a digital receiver unit. The digital receiver unit comprises a data recovery system that extracts the framing bits from the received data stream in order to recover a payload data stream. The data recovery system, based on the received data stream, also produces a clock signal that is precisely synchronized with respect to the recovered payload data stream. This clock signal may then be used by other components in order to process the payload data stream that is recovered by the data recovery system.

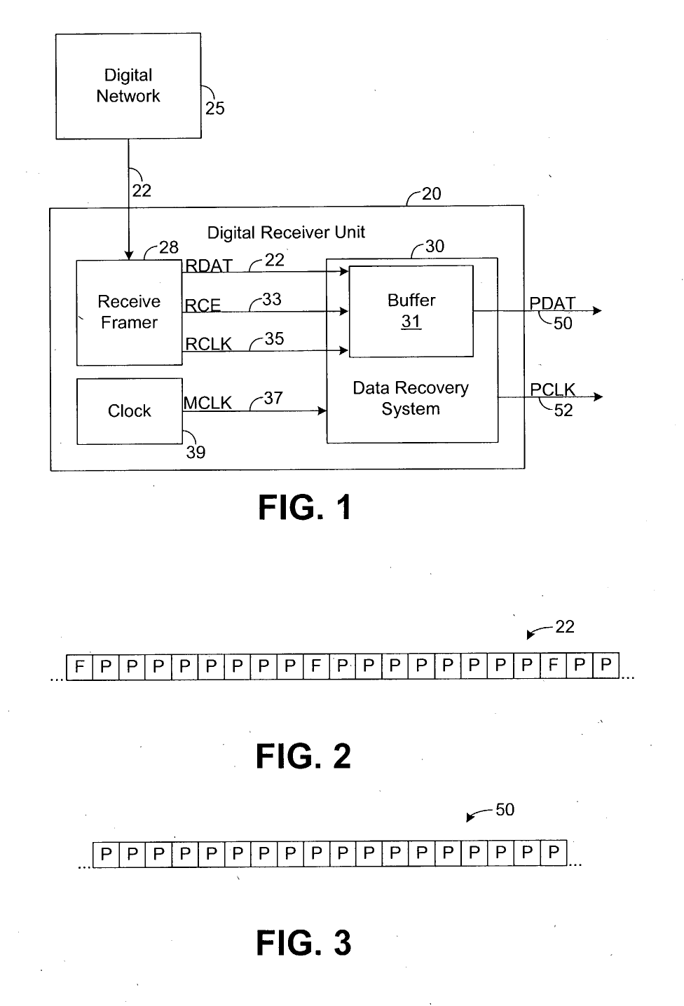

FIG. 1 depicts a digital receiver unit 20 in accordance with an exemplary embodiment of the present invention. As shown by FIG. 1, the receiver unit 20 preferably receives a framing data stream 22 from a digital data source, such as a digital network 25, for example. The framing data stream 22 comprises framing bits and payload bits. For example, as shown by FIG. 2, the framing data stream 22 may comprise a framing bit for every eight payload bits, although other arrangements of the framing data stream 22 are possible.

As shown by FIG. 1, the framing data stream 22 is preferably received by a receive framer 28 that analyzes the received framing data stream 22. The receive framer 28 passes the received data stream 22, also referred to as “RDAT,” to a data recovery system 30. As will be described n more detail hereafter, the data recovery system 30 stores the payload bits of RDAT 22 into a buffer 31 and then outputs a payload data stream from this buffer 31.

The receive framer 28, via conventional techniques, also produces a clock enable signal 33, referred to as “RCE,” and a clock signal 35, referred to as “RCLK,” and passes these signals 33 and 35 to the data recovery system 30. RDAT 22 and RCE 33 are preferably synchronized with respect to RCLK 35. Indeed, although other frequency relationships between RDAT 22 and RCLK 35 are possible, each cycle or period of RCLK 35 corresponds to a bit of RDAT 22 in one exemplary embodiment, which will be described in more detail hereafter. In addition, RCE 33 preferably indicates whether the bit of RDAT 22 being received by the data recovery system 30 is a framing bit or a payload bit. As an example, RCE 33 may be asserted for each received RDAT bit that is a framing bit and may be deasserted for each received RDAT bit that is a payload bit.

The data recovery system 30 preferably receives a master clock signal 37, referred to as “MCLK,” from a clock 39. Based on RDAT 22, RCE 33, RCLK 35, and MCLK 37, the data recovery system 30 produces two signals 50 and 52, respectively referred to as “PDAT” and “PCLK.” In this regard, the data recovery system 30 extracts the framing bits from RDAT 22 in order to produce PDAT 50, which is a data stream that comprises the payload bits buffered by the buffer 31, and the data recovery system 30 produces PCLK 52, which is a clock signal synchronized with respect to PDAT 50.

For illustrative purposes, refer to FIG. 3, which depicts the data stream portion shown by FIG. 2 once the portion has passed through the data recovery system 30. As can be seen by comparing FIGS. 2 and 3, each of the framing bits has been removed thereby leaving only payload bits in the portion shown by FIG. 3.

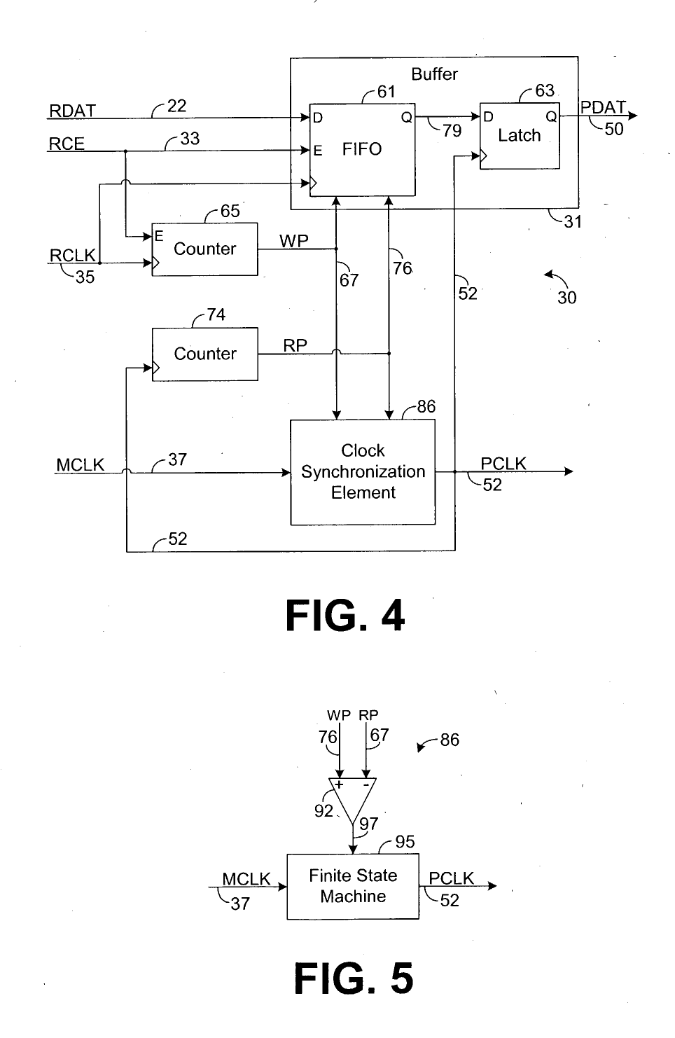

FIG. 4 depicts an exemplary embodiment of the data recovery system 30. As shown by FIG. 4, each of the signals RDAT 22, RCE 33, and RCLK 35 is provided to the buffer 31. Note that various configurations of the buffer 31 are possible. In the exemplary embodiment shown by FIG. 4, the buffer 31 comprises a first-in, first-out buffering element 61, referred to hereafter as “FIFO,” and the buffer 31 also comprises a latch 63, which will be described in more detail hereafter.

For each cycle of RCLK 35, the FIFO 61 stores the bit of RDAT 22 currently being received by the FIFO 61, if the FIFO 61 is enabled by RCE 33. In this regard, the FIFO 61 is preferably enabled by RCE 33 when the RDAT bit being received by the FIFO 61 is a payload bit. As an example, as described above, RCE 33 may be asserted when the FIFO 61 is receiving a payload bit and may be deasserted when the FIFO 61 is receiving a framing bit. In such an example, the FIFO 61 is configured to analyze RCE 33 for each cycle of RCLK 35. If RCE 33 is asserted, the FIFO 61 stores the RDAT bit being received by it. However, if RCE 33 is deasserted, the FIFO 61 refrains from storing the RDAT bit being received by it. Therefore, framing bits from RDAT 22 are essentially ignored by the FIFO 61, and payload bits from RDAT 22 are stored in the FIFO 61 on a first-in, first-out basis.

When the FIFO 61 stores a payload data bit, the FIFO 61 stores the bit at a memory location within the FIFO 61 based on a signal 67, referred to as a “write pointer” or “WP,” received from a counter 65. In this regard, although other counter sizes are possible, the counter 65 is preferably a log₂(n) bit counter where “n” corresponds to the bit length of the FIFO 61. For example, if the FIFO 61 comprises sixteen different one-bit memory locations for storing sixteen different RDAT bits, then the counter 65 preferably produces a four (4) bit write pointer 67 capable of pointing to or, in other words, identifying each different FIFO memory location. Further, when the FIFO 61 stores an RDAT bit, the FIFO 61 preferably stores the RDAT bit at the memory location identified by the write pointer 67.

In addition, for each cycle of RCLK 35, the counter 65 preferably increments the value of the write pointer 67, if the counter 65 is enabled by RCE 33. In this regard, the counter 65, like the FIFO 61, is preferably enabled when a payload bit is being received by the FIFO 61. As an example, assuming that RCE 33 is asserted when a payload bit is being received by the FIFO 61 and that RCE 33 is deasserted when a framing bit is being received by the FIFO 61, as described above, the counter 65 is preferably enabled when RCE 33 is asserted and is disabled when RCE 33 is deasserted. In other words, the counter 65 is enabled when the FIFO 61 is enabled. Therefore, for each cycle of RCLK 35, the FIFO 61 stores the RDAT bit being received by it and the counter 65 increments the write pointer 67 if a payload bit is being received by the FIFO 61. If a framing bit is instead being received by the FIFO 61, the FIFO 61 does not store the current RDAT bit, and the counter 65 does not increment the write pointer 67.

As shown by FIG. 4, the data recovery system 30 also preferably comprises another counter 74, which produces a signal 76, referred to as a “read pointer” or “RP.” Like counter 65, the counter 74 is preferably a log₂(n) bit counter where “n” corresponds to bit length of the FIFO 61, although other counter sizes are possible in other embodiments. For example, if the FIFO 61 comprises sixteen different one-bit memory locations for storing sixteen different RDAT bits, then the counter 74 preferably produces a four (4) bit read pointer 76 capable of pointing to or, in other words, identifying each different FIFO memory location. Further, the FIFO 61 is preferably configured to output, as signal 79, the bit value at the memory location currently identified by the read pointer 76, and the counter 74 is preferably configured to increment the read pointer 76 for every cycle or period of PCLK 52.

Note that the FIFO 61 is preferably a circular buffer based on the write and read pointers 67 and 76 produced by counters 65 and 74, respectively. In this regard, for each payload bit received by the FIFO 61 from RDAT 22, the FIFO 61 stores the payload bit at the FIFO memory location identified by the write pointer 67, and the write pointer 67 is also incremented such that the next payload bit received by the FIFO 61 is stored at the next successive FIFO memory location. Further, for each cycle of PCLK 52, the read pointer 76 is incremented causing the FIFO 61 to output a new payload bit stored at the memory location now identified by the read pointer 76. Thus, provided that the write and read pointers 67 and 76 do not pass one another in the FIFO 61, no data overruns occur in the FIFO 61, and the payload bits are successfully stored in and read out of the FIFO 61 on a first-in, first-out basis.

Note that each bit value output by the FIFO 61 is preferably latched by a latch 63 based on PCLK 52. In this regard, for each new cycle of PCLK 52, the latch 63 preferably outputs, as a PDAT bit, the bit value of signal 79 received by the latch 63 during the previous cycle of PCLK 52. In other words, the latch 63 latches the value of signal 79 when clocked by PCLK 52.

As shown by FIG. 4, PCLK 52 is produced by a clock synchronization element 86, which outputs PCLK 52 based on MCLK 37 and the pointers 67 and 76 produced by the counters 65 and 74. In this regard, the frequency of MCLK 37 is preferably at least twice the approximate expected frequency of PDAT 50. Note that the approximate expected frequency of PDAT 50 is preferably equal to the expected approximate frequency of payload bits to be received by the FIFO 61 from RDAT 22. For example, if it is expected that the FIFO 61 is to receive approximately 8000 payload bits and 1000 framing bits every second, then the approximate expected frequency of PDAT 50 is 8 kilo-bits per second (kbs).

Although the precise frequency of PDAT 50 is not likely to be known prior to the communication of RDAT 22 to the receiver unit 20, it is possible to predict the approximate frequency of PDAT 50 by knowing the expected approximate frequency of RDAT 22 and the approximate ratio of framing bits to payload bits of RDAT 22. In this regard, the approximate frequency of PDAT 50 may be predicted according to the following equation:

$${f}_{p} = {f}_{r} * \frac{x}{x + y}$$

where “fₚ” is the predicted or expected approximate frequency of PDAT 50, where “fᵣ” is the expected approximate frequency of RDAT 22, and where the ratio of payload bits to framing bits corresponds to x/y.

Moreover, the frequency (fₘ) of MCLK 37 is preferably at least twice the expected approximate frequency (fₚ) of PDAT 50 or, in other words, is at least 2(fₚ). Further, except when the element 86 determines that the timing of a transition of PCLK 52 should be adjusted as will be described in more detail hereafter, the clock synchronization element 86 is configured to output PCLK 52 at a frequency (“f_{pclk}”) according to the following equation:

f_{pclk}=fₘ/└fₘ/fₚ┘,

where └fₘ/fₚ┘ corresponds to the value of fₘ/fₚ rounded down to the nearest integer.

Thus, if fₘ/fₚ is between 4.0 and 5.0, for example, then the element 86 generates PCLK 52, based on MCLK 37, by transitioning PCLK 52 once for every four transitions of MCLK 37 such that the actual frequency of PCLK 52 is one-fourth the frequency of MCLK 37, except when the timing of a transition of PCLK 52 is adjusted as will be described in more detail hereafter. Note that other ratios between the frequency of MCLK 37 and the expected approximate frequency of PDAT 50 are possible in other embodiments. Indeed, higher ratios of fₘ/fₚ generally help to produce finer resolution and lower jitter in PCLK 52.

Since counter 65 is clocked by RCLK 35 when enabled by RCE 33 and since counter 74 is clocked by PCLK 52, the write and read pointers 67 and 76 will not likely be incremented in unison. Indeed, it is likely that one of the counters 65 or 74 will be clocked at a higher rate than the other counter 65 or 74 unless steps are taken by the clock synchronization element 86 to account for the frequency difference. Moreover, the clock synchronization element 86 is preferably configured to compare the write and read pointers 67 and 76 and to periodically adjust the frequency of PCLK 52 by delaying or accelerating a transition of PCLK 52 depending on the comparisons of the write and read pointers 67 and 76. More specifically, the clock synchronization element 86 is preferably configured to detect when a difference between the values of the write and read pointers 67 and 76 is less than a specified threshold and to then temporarily adjust the frequency of PCLK 52 by delaying or accelerating one or more PCLK transitions such that the difference returns to a level above the threshold. As a result, the write and read pointers 67 and 76 are prevented from passing each other in the FIFO 61.

As an example, assume that f_{pclk} is higher than the actual rate at which payload bits are received by the FIFO 61 from RDAT 22. In such a situation, the counter 74 is generally clocked at a higher rate than counter 65, and the read pointer 76, therefore, generally advances through the memory locations of the FIFO 61 more quickly than the write pointer 67. Moreover, the clock synchronization element 86 is configured to periodically adjust the frequency of PCLK 52 such that (1) the read pointer 76 is delayed with respect to the write pointer 67 when the read pointer 76 is within a specified number of increments from passing the write pointer 67 and (2) the read pointer 67 is accelerated with respect to the write pointer 67 when the read pointer 76 is greater than the specified number of increments from passing the write pointer 67. By adjusting the frequency of PCLK 52 based on comparisons of the write and read pointers 67 and 76 in such a manner, the read pointer 76 can be prevented from passing the write pointer 67, thereby preventing data overruns in the FIFO 61 even though f_{pclk} is higher than the actual rate at which payload bits are received by the FIFO 61.

In another example, assume that f_{pclk} is lower than the actual rate at which payload bits are received by the FIFO 61 from RDAT 22. In such a situation, the counter 65 is generally clocked at a higher rate than counter 74, and the write pointer 67, therefore, generally advances through the memory locations of the FIFO 61 more quickly than the read pointer 76. Moreover, the clock synchronization element 86 is configured to periodically adjust the frequency of PCLK 52 such that (1) the read pointer 76 is accelerated with respect to the write pointer 67 when the write pointer 67 is within a specified number of increments from passing the read pointer 76 and (2) the read pointer 67 is delayed with respect to the write pointer 67 when the write pointer 67 is greater than the specified number of increments from passing the read pointer 76. By adjusting the frequency of PCLK 52 based on comparisons of the write and read pointers 67 and 76 in such a manner, the write pointer 67 can be prevented from passing the read pointer 76, thereby preventing data overruns in the FIFO 61, even though f_{pclk} is lower than the actual rate at which payload bits are received by the FIFO 61.

There are various configurations for the clock synchronization element 86 that may be employed to implement the present invention. Indeed, the clock synchronization element 86 may be implemented in hardware, software, or any combination thereof. In one exemplary embodiment depicted by FIG. 5, the clock synchronization element 86 comprises a comparator 92 and a finite state machine 95. The comparator 92 is configured to receive and compare the write and read pointers 67 and 76, and the comparator 92 transmits a signal 97, referred to as “ACC,” based on the comparison of the two pointers 67 and 76. In particular, the comparator 92 asserts ACC 97 if the number of increments between the write pointer 67 and the read pointer 76 is less than a specified threshold. Note that the number of increments between the write pointer 67 and the read pointer 76 may be represented as “y” in the following equations:

y=WP−RP, if WP>RP; and

y=WP−RP+n, if WP<RP,

where “WP” represents the value of the write pointer 67, “RP” represents the value of the read pointer 76, and “n” represents the bit length of FIFO 61. Note that if the number of increments between the write pointer 67 and the read pointer 76 is greater than the specified threshold, then the comparator 92 is preferably configured to deassert ACC 97. For illustrative purposes, the term “asserted” will refer to a logical high bit value, and the term “deasserted” will refer to a logical low bit value. However, in other examples, the term “asserted” may refer to a logical low bit value, and the term “deasserted” may refer to a logical high bit value.

Although the specified threshold may correspond to other values in other embodiments, the specified threshold used to determine whether ACC 97 is to be asserted preferably corresponds to n/2, where “n” again represents the bit length of FIFO 61 and where the bit length of each of the pointers 67 and 76 is preferably log₂(n).

In a preferred embodiment, the finite state machine 95 defines an “R” number of states, where R may be defined by the following equation:

R=┌fₘ/fₚ┐,

where fₘ represents the frequency of MCLK 37, where fₚ, as described above, represents the predicted approximate frequency of PCLK 50, and where ┌fₘ/fₚ┐ represents the value of fₘ/fₚ rounded up to the nearest integer.

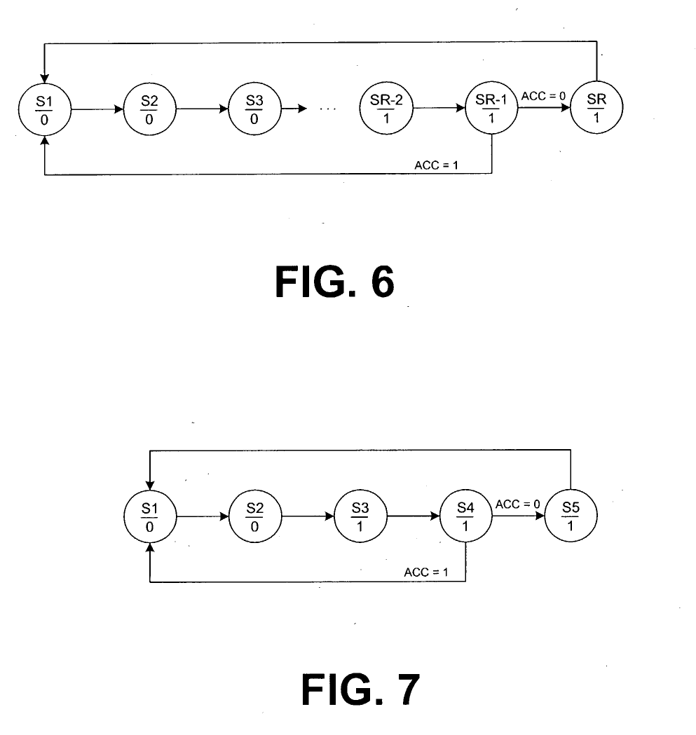

In a preferred embodiment, the finite state machine 95 is configured to successively step through each of its states, except sometimes the last state depending on the value of ACC 97. In this regard, FIG. 6 depicts an exemplary state diagram for the finite state machine 95. The states are preferably grouped into approximately two halves, a lower half and an upper half, in which the finite state machine 95 is configured to deassert PCLK 50 when in each of the states in the lower half and in which the finite state machine 95 is configured to assert PCLK 50 when in each of the states of the upper half. Note that, for each iteration of the state diagram, the finite state machine 95 steps through each of the states of the lower half before stepping into any of the states of the upper half, and the finite state machine 95 steps through each of the states (except sometimes the last state depending on the value of ACC 97) of the upper half before stepping back into the lower half states.

Note further that the finite state machine 95 is configured to step into a new state upon a transition of MCLK 37 into a new cycle or period. Thus, the finite state machine 95 is initially in state “S1” and, therefore, initially deasserts PCLK 52. Upon a transition of MCLK 37 into a new period, the finite state machine 95 steps into the next state “S2.” Assuming that “S2” is within the lower half of the states, the finite state machine 95 keeps PCLK 52 deasserted. Upon a transition of MCLK into a new period, the finite state machine 95 steps into the next state “S3.” Assuming that “S3” is within the lower half of the states, the finite state machine 95 keeps PCLK 52 deasserted. The finite state machine 95 continues stepping into the lower half states in this manner until all of the lower half states half been stepped into.

Once all of the lower half states have been stepped into, the finite state machine 95 steps into the first upper level state upon the next transition of MCLK 37 to a new period. Upon stepping into the first upper half state, the finite state machine 95 transitions PCLK 52 from a deasserted signal to an asserted signal or, in other words, asserts PCLK 52. The finite state machine 95 then steps into a new upper half state for each new period of MCLK 37. For each such upper half state, the finite state machine 95 keeps PCLK 52 asserted. When the finite state machine 95 steps into the penultimate upper half state “SR-1,” the finite state machine 95 determines whether or not ACC 97 is asserted. If asserted, the finite state machine 95 does not step into the last state “SR” upon a transition of MCLK 37 into a new period but rather skips state “SR” and steps into the first lower half state “S1.” The aforementioned process is then repeated. However, if ACC 97 is deasserted when the finite state machine 95 is in the penultimate state “SR-1,” then the finite state machine 95, instead of skipping the last state “SR,” steps into the last state “SR” upon a transition of MCLK 37 into a new period. As a result, the transition of PCLK 52 to a deasserted state and, therefore, the next clocking of counter 74 (FIG. 4) is delayed by one MCLK cycle. By implementing the state diagram shown by FIG. 6, the read pointer 76 is prevented from passing the write pointer 67 in the FIFO 61.

In this regard, when the counter 74 is clocked at a faster rate than counter 65 such that the read pointer 76 gains on the write pointer 67 or, in other words, increments closer to the value of the write pointer 67, the ACC 97 is eventually deasserted when the read pointer 76 is less than n/2 increments from the write pointer 67. When this occurs, the clock synchronization element 86 delays the read pointer 76 with respect to the write pointer 67 by entering the last state of the state diagram depicted by FIG. 6. However, when the counter 65 is clocked at a faster rate than the counter 74 such that the write pointer 67 gains on the read pointer 76, the ACC 97 is eventually asserted when the write pointer 67 is less than n/2 increments from the read pointer 76. When this occurs, the clock synchronization element 86 accelerates the read pointer 76 with respect to the write pointer 76 by skipping the last state of the state diagram depicted by FIG. 6.

### Operation

An exemplary use and operation of the data recovery system 30 and associated methodology are described hereafter.

For illustrative purposes, assume that the actual frequency of the payload bits within RDAT 22 is less than f_{cplk}. As noted above, the clock synchronization element 86 preferably sets the frequency of PCLK 52 to f_{pclk}, except that the frequency of PCLK 52 may be temporarily adjusted from time-to-time, as will be described in more detail hereafter. Therefore, for the present example, the read pointer 76 is generally incremented faster than the write pointer 67, and the read pointer 76 tends to gain on the write pointer 67 without any adjustment to the frequency of PCLK 52 by the clock synchronization element 86.

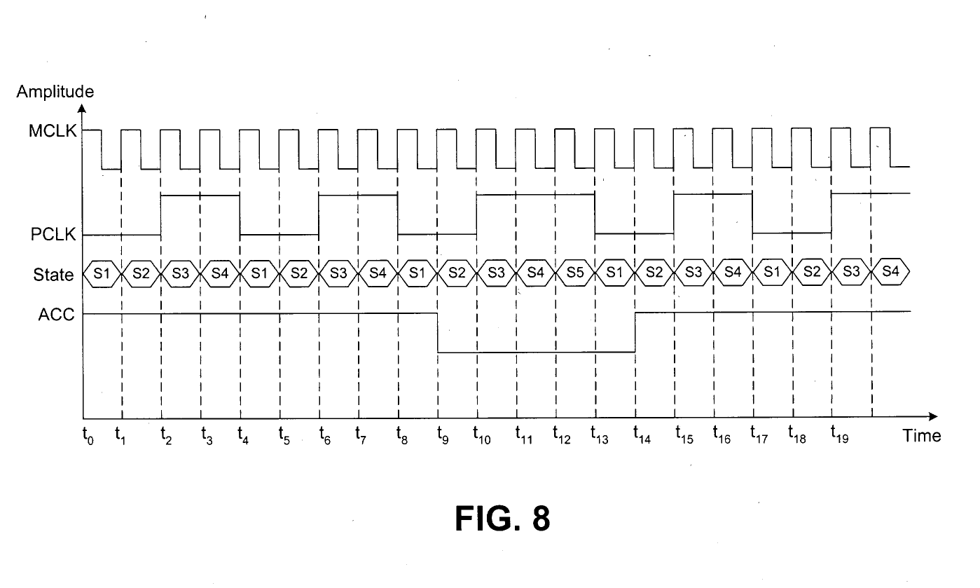

For illustrative purposes, also assume that fₘ/fₚ equals 4.25. In such an example, the value 4.25 is rounded up to the nearest integer (i.e., 5) to determine “R,” which preferably equals the number of states defined by the finite state machine 95. Indeed, FIG. 7 illustrates a state diagram for the state machine 95 for the present example. Further, FIG. 8 depicts a timing diagram for MCLK 37, PCLK 52, and ACC 97 for the present example, and FIG. 8 also shows the timing relationships between the states of the finite state machine 95 and the foregoing signals (MCLK 37, PCLK 52, and ACC 97).

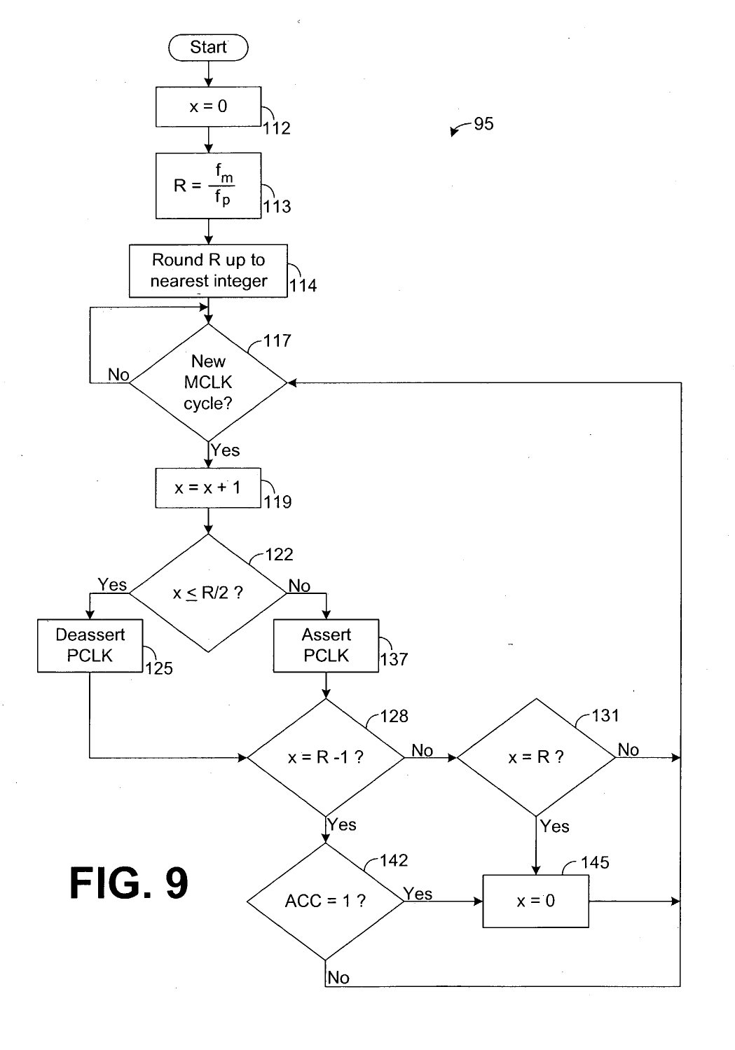

As shown by blocks 112-114 of FIG. 9, a value “x” and the value “R” are initialized. In this regard, x is initialized to zero (0) and R is initialized to five (5) according to the equation R=┌fₘ/fₚ┐. Once a new MCLK cycle is begun at time to in FIG. 8, x is incremented, as shown by blocks 117 and 119, and the finite state machine 95 enters the state corresponding to the incremented value of x. In the first MCLK cycle, x is incremented to a value of one (1), and the finite state machine enters state “S1,” where the current state of the state machine 95, throughout the present example, corresponds to the expression “Sx.” In the present example, S1 is a lower half state, and a “yes” determination is, therefore, made in block 122. As a result, the finite state machine 95, in block 125, deasserts PCLK 52 during the time period from t₀ to t₁ shown by FIG. 8.

After deasserting PCLK 52 in block 125, the finite state machine 95 determines, in block 128 whether the current state corresponds to the penultimate state (i.e., state S4 in the present example) defined by the state machine 95. Since the state machine 95 is presently in state S1, the state machine 95 makes a “no” determination in block 128 and proceeds to block 131 to determine whether the current state corresponds to the last state (i.e., state S5 in the present example) defined by the state machine 95. Since the state machine 95 is presently in state S1, the state machine 95 makes a “no” determination in block 131 as well and returns to block 117.

Upon the occurrence of the next MCLK cycle at time t₂ in FIG. 8, x is incremented to the value two (2), and the state machine 95 enters state S2. This state is still a lower half state, and the state machine 95, therefore, keeps PCLK 52 deasserted during the time period from t₁ to t₂ shown by FIG. 8. Since S2 is a lower half state, “no” determinations are again made in blocks 128 and 131, and the state machine 95 returns to block 117.

Upon the occurrence of the next MCLK cycle at time t₂ in FIG. 8, x is incremented to three (3), and the state machine 95 enters state S3. This state is an upper half state, and a “no” determination is, therefore, made in block 122. Accordingly, the state machine 95 asserts PCLK 52, in block 137, during the time period from t₂ to t₃ shown by FIG. 8. Moreover, S3 is neither the penultimate state nor the last state of the state diagram shown by FIG. 7, and the state machine 95, therefore, makes “no” determinations in blocks 128 and 131. As a result, the state machine 95 returns to block 117.

Upon the occurrence of the next MCLK cycle at time t₃ in FIG. 8, x is incremented to four (4), and the state machine 95 enters state S4. Since S4 is an upper half state, a “no” determination is made in block 122, and the state machine 95, therefore, proceeds to block 137 and keeps PCLK 52 asserted during the time period from t₃ to t₄. Furthermore, S4 is the penultimate state of the state diagram depicted by FIG. 7, and a “yes” determination is, therefore, made in block 128. Accordingly, in block 142, the state machine 95 checks ACC 97. ACC 97 is preferably asserted if the read pointer 76 is within a specified number of increments from the write pointer 67.

For example, in the exemplary embodiment described above, ACC 97 is deasserted if the read pointer is less than n/2 increments from the write pointer 67, where “n” represents the bit length of FIFO 61. Generally, a deasserted ACC 97 indicates that the read pointer 76 is sufficiently close to the write pointer 76 such that it is desirable to delay the read pointer 76 with respect to the write pointer 67 in an effort to ensure that the read pointer 76 will not pass the write pointer 67 in the FIFO 61. Conversely, an asserted ACC 97 generally indicates that the read pointer 76 is sufficiently far from the write pointer 76 such that it is not desirable to delay the read pointer 76 by having the finite state machine 95 enter the last state (i.e., state S5 in the present example).

Moreover, assuming that ACC 97 is presently asserted, the state machine 95 makes a “yes” determination in block 142, and sets x to zero (0) in block 145 before returning to block 117. Thus, on the next MCLK cycle at time t₄, the state machine 95 enters state S1 and repeats the aforedescribed process. Indeed, the aforedescribed process is repeated, as shown by FIG. 8, until the read pointer 76 comes sufficiently close to write pointer 67 such that ACC 97 is deasserted. In this regard, after ACC 97 is deasserted, the state machine 95 makes a “no” determination in block 142 when the state machine 95 reaches state S4. In the example shown by FIG. 8, this determination is made during the period between t₁₁ and t₁₂. Thus, during this time period, the state machine 95 bypasses block 145, and returns to block 117 without resetting x, which corresponds to the value four (4).

Thus, upon the occurrence of the next MCLK cycle at time t₁₂ in FIG. 8, the state machine 95 increments x to five (5), and the state machine 95 enters state S5. Since S5 is an upper half state, the state machine 95 keeps PCLK 52 asserted during the time period from t₁₂ to t₁₃. Note that, as a result, the asserted cycle of PCLK 52 is extended by one MCLK cycle, as shown by FIG. 8. More specifically, the asserted cycle of PCLK 52 from the time period between t₁₀ and t₁₃ lasts for three (3) MCLK cycles whereas the other asserted cycles of PCLK 52 when state S5 is not performed last for only two (2) MCLK cycles.

After implementing block 137 while in state S5, the state machine 95 makes a “no” determination in block 128 and a “yes” determination in block 131. Thus, before returning to block 117, the state machine 95 sets x to zero (0) in block 145. As a result, x is incremented to one (1) for the next MCLK cycle at time t₁₃, and the state machine 95 again enters state S1.

Due to the one MCLK cycle extension of PCLK 52 that occurs as a result of implementation of state S5 when ACC 97 is deasserted, the next increment of the read pointer 76 is delayed with respect to the write pointer 67. Therefore, the separation between the read pointer 76 and the write pointer 67 is preferably increased such that ACC 97 again returns to an asserted state at time t₁₄.

Moreover, the aforedescribed process is continually repeated. Therefore, as the read pointer 76 gains on the write pointer 76, the read pointer 76 is periodically delayed such that the read pointer 67 does not pass the write pointer 76 in the buffer 61.

Note that in other embodiments, the write pointer 76 may instead gain on the read pointer 67. Such an embodiment exists when the actual frequency of payload bits within RDAT 22 is greater than f_{pclk}. In such a situation, the write pointer 67 tends to gain on the read pointer 76 until the write pointer 67 is less than a specified threshold of increments (e.g., n/2), from the read pointer 76, at which point ACC 97 is asserted. As a result of the assertion of ACC 97, the state S5 is not performed for the next iteration of the state diagram shown by FIG. 6, thereby accelerating the read pointer 67 with respect to the write pointer 76. Accordingly, the separation between the write pointer 76 and the read pointer 67 is increased such that ACC 97 is again deasserted. Note that the architecture and functionality of the finite state machine 95 in such an example adheres to the state diagram shown by FIG. 6 and the process shown by FIG. 9 and is, therefore, similar to the functionality described in the aforedescribed example where the actual payload frequency of RDAT 22 is less than f_{pclk}.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Now, therefore, the following is claimed:

1. A system for recovering a payload data stream from a framing data stream, comprising:
a buffer configured to receive said framing data stream and to store payload bits of said framing data stream, said buffer further configured to transmit said payload bits based on a clock signal;
a first counter configured to produce a first value, said first counter configured to update said first value for each of said payload bits stored in said buffer;
a second counter configured to produce a second value, said second counter configured to update said second value based on said clock signal; and
a clock synchronization element coupled to said first and second counters, said clock synchronization element configured to compare said first and second values and to control a frequency of said clock signal based on comparisons of said first and second values.

2. The system of claim 1, wherein each of said values has a total number of bits corresponding to log₂(n), wherein n corresponds to a total number of memory locations for storing said payload bits within said buffer.

3. The system of claim 1, wherein said clock synchronization element, based on one of said comparisons, is configured to make a determination as to whether a difference between said first and second values exceeds a threshold value, said clock synchronization element further configured to adjust said frequency of said clock signal in response to said determination.

4. The system of claim 1, wherein said buffer is configured to receive a second clock signal and a clock enable signal, said buffer further configured to store a bit of said framing data signal when clocked by said clock signal and enabled by said clock enable signal, and wherein said first counter is configured to receive said second clock signal and said clock enable signal, said first counter further configured to update said first value when clocked by said second clock signal and enabled by said clock enable signal.

5. The system of claim 1, wherein said buffer comprises a first-in, first-out (FIFO) buffering element, said buffering element configured to store each of said payload bits at locations in said buffering element based on said first value, said buffering element further configured to transmit said bits based on said second value.

6. The system of claim 5, wherein said buffer further comprises a latch configured to latch, based on said clock signal, said payload bits transmitted by said buffering element.

7. A system for recovering a payload data stream from a framing data stream, comprising:
a buffer configured to receive said framing data stream, a first clock signal, a second clock signal, and a first clock enable signal, said buffer configured to store bits of said framing data stream when clocked by said first clock signal and enabled by said clock enable signal, said buffer further configured to transmit said bits based on said second clock signal;
a first counter configured to receive said first clock signal and said clock enable signal, said first counter configured to produce a first value, said first counter further configured to update said first value when clocked by said first clock signal and enabled by said clock enable signal;
a second counter configured to produce a second value, said second counter configured to update said second value based on said second clock signal; and
a clock synchronization element coupled to said first and second counters, said clock synchronization element configured to perform a comparison between said first value and said second value, said clock synchronization element further configured to control a frequency of said second clock signal based on said comparison.

8. The system of claim 7, wherein each of said values has a total number of bits corresponding to log₂(n), wherein n corresponds to a total number of memory locations for storing said bits within said buffer.

9. The system of claim 7, wherein said clock synchronization element, based on said comparison, is configured to make a determination as to whether a difference between said first and second values exceeds a threshold value, said clock synchronization element further configured to adjust said frequency of said second clock signal in response to said determination.

10. The system of claim 7, wherein said buffer comprises a first-in, first-out (FIFO) buffering element, said buffering element configured to store each of said bits at locations in said buffering element based on said first value, said buffering element further configured to transmit said bits based on said second value.

11. The system of claim 10, wherein said buffer further comprises a latch configured to latch, based on said second clock signal, said bits transmitted by said buffering element.

12. A system for recovering a payload data stream from a framing data stream, comprising:
a buffer configured to receive said framing data stream and to store payload bits of said framing data stream, said buffer further configured to transmit said payload data stream from said buffer based on said stored payload bits;
a first counter configured to count a number of said payload bits stored to said buffer, said first counter configured to transmit a first signal indicative of said number counted by said first counter;
a second counter configured to count a number of said payload bits transmitted from said buffer, said second counter configured to transmit a second signal indicative of said number counted by said second counter; and
a clock synchronization element configured to produce a clock signal that is synchronized with said payload data stream based on comparisons of said first and second signals.

13. The system of claim 12, wherein said buffer comprises a first-in, first-out buffering element and a latch, said buffering element coupled to said latch.

14. The system of claim 12, wherein each of said signals has a total number of bits corresponding to log₂(n), wherein n corresponds to a total number of memory locations for storing said bits within said buffer.

15. The system of claim 12, wherein said clock synchronization element, based on-one of said comparisons, is configured to make a determination as to whether a difference between said first and second signals exceeds a threshold value, said clock synchronization element further configured to adjust a frequency of said clock signal in response to said determination.

16. A method for recovering a payload data stream from a framing data stream, comprising the steps of:
storing payload bits of said framing data stream in a buffer;
transmitting said payload bits from said buffer based on a clock signal;
clocking a first counter for each of said payload bits stored in said buffer;
clocking a second counter via said clock signal;
comparing values produced by said first and second counters; and
controlling a frequency of said clock signal based on said comparing step.

17. The method of claim 16, wherein each of said values has a total number of bits corresponding to log₂(n), wherein n corresponds to a total number of memory locations for storing said payload bits within said buffer.

18. The method of claim 16, wherein said comparing step further comprises the step of making a determination as to whether a difference between said values exceeds a threshold value, and wherein said controlling step further comprises the step of adjusting said frequency of said clock signal in response to said determination.

19. The method of claim 16, wherein said comparing step further comprises the step of comparing a difference between said values to a threshold value.

20. The method of claim 16, wherein said storing step is based on a second clock signal and a clock enable signal, and wherein said clocking a first counter step is based on said second clock signal and said clock enable signal.

21. The method of claim 16, wherein said transmitting step comprises the step of latching said payload bits based on said clock signal.

22. The method of claim 21, wherein said storing step is based on one of said values.

23. A method for recovering a payload data stream from a framing data stream, comprising the steps of:
storing payload bits of said framing data stream to a buffer;
transmitting said payload data stream from said buffer;
counting a number of said payload bits stored to said buffer via said storing step;
producing a first signal indicative of said number of said payload bits stored to said buffer;
counting a number of said payload bits transmitted from said buffer via said transmitting step;
producing a second signal indicative of said number of said payload bits transmitted from said buffer;
comparing said first and second signals; and
producing a clock signal that is synchronized with said payload data stream based on said comparing step.

24. The method of claim 23, wherein each of said signals has a total number of bits corresponding to log₂(n), wherein n corresponds to a total number of memory locations for storing said payload bits within said buffer.

25. The method of claim 23, wherein said comparing step further comprises the step of making a determination as to whether a difference between said signals exceeds a threshold value, and wherein said producing step further comprises the step of adjusting a frequency of said clock signal in response to said determination.

26. The method of claim 23, wherein said comparing step further comprises the step of comparing a difference between said signals to a threshold value.

27. The method of claim 23, wherein said storing step is based on a second clock signal and a clock enable signal, and wherein said counting a number of said payload bits stored to said buffer step is based on said second clock signal and said clock enable signal.

28. The method of claim 23, wherein said transmitting step comprises the step of latching said payload bits based on said clock signal.

29. The method of claim 28, wherein said storing step is based on said first signal.
